(19) United States
(12) Patent Application Publication
(10) Pub. No.: US 2010/0023860 A1
(43) Pub. Date: Jan. 28, 2010

(54) SYSTEM AND METHOD FOR LISTENING TO INTERNET RADIO STATION BROADCAST AND PROVIDING A LOCAL CITY RADIO RECEIVER APPEARANCE TO CAPTURE USERS' PREFERENCES

(76) Inventor: Raul Fernando Toro-Lisoni, Santiago (CL)

Correspondence Address: SHERIDAN ROSS PC, 1560 BROADWAY, SUITE 1200, DENVER, CO, 80202, US

(21) Appl. No.: 12/177,508

(22) Filed: Jul. 22, 2008

(51) Int. Cl. G06F 3/048

(52) U.S. Cl. 715/716

(57) ABSTRACT

A web service and associated method is provided that allows a user to select and listen to various radio stations via the Internet. The user interface is uniquely adapted to provide the appearance and controls as if the user were selecting the radio station from a frequency selection with a frequency-based tuner. However, the frequency selected at the user interface is mapped to a website that streams the audio content associated with the selected channel over the Internet and the received audio content corresponds to Internet retrieved content rather than content received via an RF signal.

### FIELD OF THE INVENTION

The invention is generally related to Internet computer networks facilities and more particularly to linking a large number of sources that emit the contents of radio broadcasting via the Web.

### BACKGROUND

AM and FM radio frequency broadcasting is also available via Internet. Audio streaming is obtained in computers where sequences of sound, captured by a microphone, are digitized into sequences of numbers. In order to compress the information, some processing is necessary. Perhaps the earliest algorithms used in speech encoding (and audio data compression in general) were the A-law algorithm and the μ-law algorithm.

Radio broadcasters generally encode audio streams in more than one format, typically Windows Media, Quick Time or Real Time Player, available, depending on the operating systems for Windows, Macintosh or Unix.

The standard audio compression currently used to stream audio content over the Internet is MP3 encoding, a filtering technique that looses part of the non-audible data. MP3 is an MPEG-1 Audio Layer 3 music format developed to store music in CDs. When transmitted over the Internet, the bits are “streamed” over a TCP/IP connection, then reassembled and played within about 2 seconds. Therefore, streaming MP3 radio has about a 2 second lag time.

There are three major components to an MP3 stream: 1) Audio stream source; 2) Audio stream repeater (server); and 3) Audio stream playback. There are many methods for creating the audio stream source. One of the easiest and most popular ways to compose this stream is by using the Live365 web service, which allows Internet users with very little technological know-how to begin webcasting legal audio streams in MP3 and mp3PRO formats within minutes. Those more technologically savvy may opt for the SHOUTcast service, which utilizes Winamp and the SHOUTcast DSP plugin to deliver MP3 audio at higher bitrates. Other methods include open source technologies such as Streamcast, stream-db, IceS, and MuSE. Using open source stream source tools allows for interesting web interface possibilities like phpStreamcast.

Two of the most popular Web radio networks are Live365 and SHOUTcast. Open source alternatives include Icecast and Xiph.org, which include Ogg Vorbis streamings (that can be played by Winamp and Zinf). Collectively, these Web radio servers list thousands of Internet radio stations covering an ever-expanding variety of genres. The purpose of the server is to repeat the stream source to the audio playback software. Usually repeating this streams for Windows Media, Quick Time or Real Time Player at the same time.

Some sort of audio playback software, that is capable of reading HTTP data streams, is needed to listen to streaming MP3 audio. Some popular MP3 players are Winamp for Windows, iTunes for Macintosh and Microsoft Windows, and XMMS on UNIX/Linux.

### SUMMARY

Selection of the audio stream of a particular radio station broadcast via the Web from a large list of radio stations by country, by city, by name, and by AM/FM channel available in each city can be tedious, time consuming, and distracting. Embodiments of the present invention provide an Internet service to listen to radio broadcasts from all over the world, giving the appearance of a local city AM/FM radio receiver with few control buttons. The display or user interface shows the channel frequency (as if being received locally) and control buttons to dial up and down across frequencies for the selected location, allowing the user to change and listen to every Internet radio station in a city regardless of where the user is located. In addition, country and city selectors may also be provided to reach all radio stations available via the Internet.

In accordance with at least some embodiments of the present invention, the system may utilize an interface that gives the appearance to the user that he/she is selecting stations from the spectrum frequency at a particular location, while the user is actually selecting radio stations from websites via the wide band Internet. Thus, a mapping between websites containing streamed radio content and a “frequency” selection on the user interface may be accomplished. The mapping may depend upon the location (e.g., city, state, region, etc.) that a user has selected. This means that a user interface may map a first frequency setting to a first web address when a first location is selected and the same first frequency setting may be mapped to a second different web address when a second different location is selected.

In accordance with at least some embodiments of the present invention, dial selection preferences are recorded relating city, timing, radio station, and advertisement selections. The system may also comprise a programmable calendar time radio station selection. Furthermore, advertising may be provided and the ability to track station popularity (i.e., by determining how many users are currently connected to a particular website) may be accomplished for traditional radio stations. This is significantly more accurate than currently known rating systems that are only capable of determining a radio station's listener rating based on the amount of power required to operate an antenna.

Radio station broadcasting is received by RF antennas in radio receiver devices providing AM/FM listening. In addition, most FM radio stations of the world transmit their digitalized sound stream via Internet. There are different means to locate the site from where each radio station can be accessed. One way that a user may be able to access various radio stations via the web is to utilize a search engine. This is only useful if the user knows the name of the radio station. Another way to find radio stations is from a list of radio station links published by some Internet websites with the direct knowledge of the IP address number or using the URL name address of the AM/FM audio stream Internet provider. Again, this requires a priori knowledge of the URL name of the listing website or the audio stream provider. Moreover, the user must choose a format to receive the audio stream: Windows Media, Quick Time, Real Player or other format.

Embodiments of the present invention provide a very user-friendly interface to link to radio stations broadcasting via Internet. More particularly, each geographic location has its local set of radios stations that are reachable close from the city where the emission originates. In embodiments of the present invention, the same radio stations reachable from within a city via the spectrum frequency are put together creating the appearance of the local town receiver but reached from any place where there is Internet service. This results in an offering of excellent sound quality and automatically provides access to the most used formats to play the audio stream (e.g., Windows Media, Quick Time, Real Player, etc.)

When travelling, it is usually necessary to change the radio station each time the signal is lost due to obstacles or the long distance between sender (i.e., radio station antenna) and receiver (i.e., tuner). This is due to the decay of Radio Frequency (RF) signals as a function of transmission distance. If a user has access to Internet, the radio station will not be lost, and the signal quality can be maintained as long as the bandwidth of the Internet channel is available.

Internet sites are characterized by a set of instructions given in HTML pages sent in order to display texts, images, sounds, video and allow some control in order to perform new contents or to link to new HTML pages. It may be feasible to dynamically change the URL links of the fetched HTML page. For example, IFRAME of Internet Explorer 3, followed by many other means such as LAYER of Netscape 4, Microsoft MSRS remote scripting, JavaScript on demand, etc. may be used to accomplish a control over the HTML pages.

Alternatively, and in accordance with at least some embodiments of the present invention, the Internet receiver may utilize AJAX (Asynchronous JavaScript) and XML (extensible Mark-up Language) to set the URL links of the dial up and dial down radio station.

Div is an HTML element to divide attribute zones in the HTML page. The dial up and dial down control elements on the interface of the present invention may have their own div in order to link to different URLs.

The C language is available to control the operation of a Web service, in addition to C++, Perl, Java, PHP, and many others. At least some embodiments of the present invention may utilize PHP as the language to control the operation of the web service.

Data is necessary to keep the URL of radio stations and names, cities, and users' statistics. Data is usually kept in files or in a database. In accordance with at least some embodiments of the present invention, a MySQL database is used to store the radio stations, names, cities, and user statistics. Mapping within the database may be facilitated via use of the user interface.

The PHP, MySQL connection has the capability to recognize the user browser brand, the PC brand, and some interface characteristics allowing for an automated determination of whether the required data stream decoder to be used is Windows Media, Quick Time, or Real Player.

In accordance with at least some embodiments of the present invention, a web service is deployed to listen AM and FM radio broadcasts. The Web service links to AM/FM radio stations allowing dialing a radio station up or down (e.g., by viewing a frequency setting) and performing the selected radio station sound stream (e.g., by selecting a website corresponding to the selected frequency setting and city). The dial is organized as if the selected city radio broadcasts were tuned with a radio receiver device located close to the selected city.

The Web services provide a selection facility to change country, state and city, thereby changing the mapping between selected frequency settings and websites. The Web service may also provide statistics of users listening to broadcasting stations and their advertisement inquiries.

These and other advantages will be apparent from the disclosure of the invention(s) contained herein. The above-described embodiments and configurations are neither complete nor exhaustive. As will be appreciated, other embodiments of the invention are possible using, alone or in combination, one or more of the features set forth above or described in detail below.

### BRIEF DESCRIPTION OF THE DRAWINGS

FIG. 1 depicts a data structure listing countries and states in accordance with at least some embodiments of the present invention;

FIG. 2 depicts a data structure where each city points to a list of radio stations in accordance with at least some embodiments of the present invention;

FIG. 3 depicts a data structure where a list of local radio stations is depicted in a circular fashion in accordance with at least some embodiments of the present invention;

FIG. 4 depicts a system overview in accordance with at least some embodiments of the present invention;

FIG. 5 depicts an exemplary user interface in accordance with at least some embodiments of the present invention; and

FIG. 6 depicts a mapping of data structures in accordance with at least some embodiments of the present invention.

### DETAILED DESCRIPTION

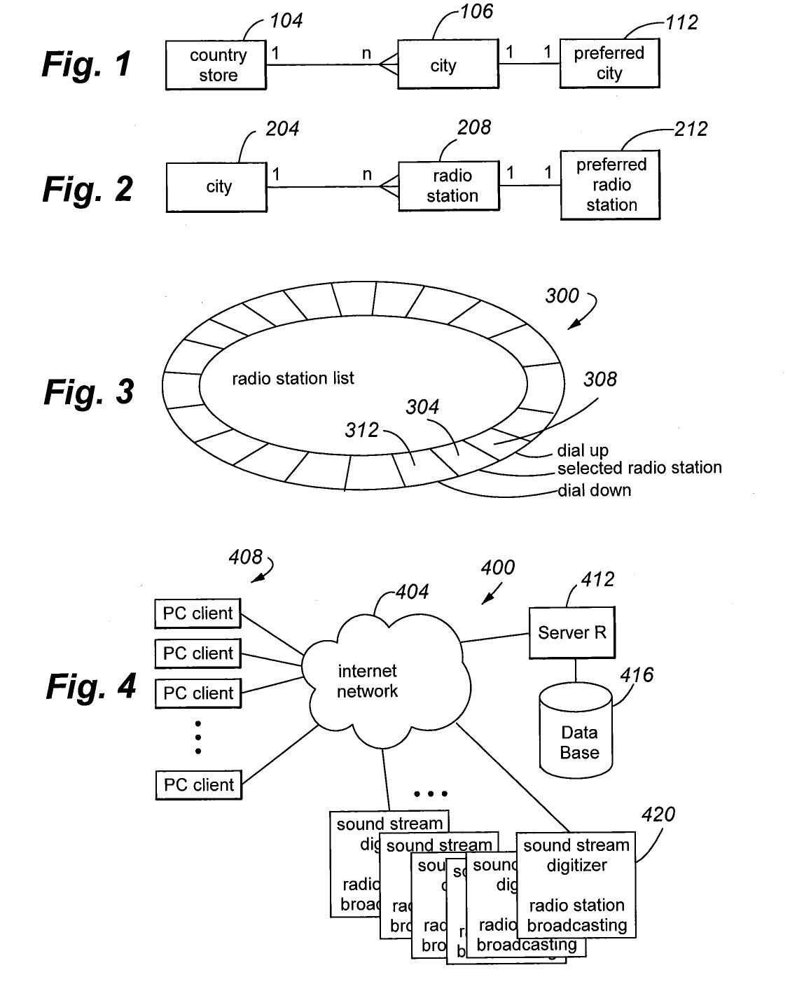

The database stores lists of countries, states, cities and the URLs of radio broadcasting stations organized in a number of different data structures depicted in FIGS. 1, 2 and 3. When a user navigates in Internet using a browser in its client PC and accesses the system, if the country, city and radio station client parameters are known, the service can start linking the client with the selected radio station URL and playing the audio stream of the selected radio station.

As shown in FIGS. 1 and 2, each country 104 has a preferred city 108 and each city 108 has a preferred radio station 112 (based on user preferences). At the beginning, these client parameters are not known to the system server, so it starts with the default selected country, city and radio station and starts playing the default audio data stream with no further questions. Later, if the user wants to select another radio to play, there are controls to select country from a list that contains all the countries in the world and all the States in the USA, and also a control to choose a city from any selected country. If the user selects another country, the user is directed automatically to the preferred city 204 of the country and, within the selected city 204, the user is directed to the preferred radio station 212 selected in this city. The preferred radio station 212 may be one of many radio stations 208 available within the city 204. If the user selects another city 204, the user is automatically set to the preferred radio station 212 in the city 208. Subsequently, the user can select another radio station with the dial up 308 and the dial down controls 312.

At any moment, each user is defined by the country 104, city 108, 204 and radio station 208 parameters. There may be 3 URLs associated with each radio station: one to play the audio data stream of the selected radio station; one to dial down (according to the spectrum frequency at the selected location where the radio station is available via RF signals); and, one to dial up (according to the spectrum frequency at the selected location where the radio station is available via RF signals). The audio content from the selected radio station 304 is played through the speakers. Thus, with just one click on any control (country, city, dial up or dial down), the radio station can change to a new audio data stream that is obtained from possibly a different web server or at least a different web address.

One aspect of the present invention is that the user only has to dial up or dial down a certain “frequency” via their user interface to select the next station for a particular city. Dialing up or down one interval may result in selecting a web address (i.e., URL) that is significantly different from the previously selected web address. The association between the “adjacent” web addresses on the user interface is generally based on a selected location (e.g., country, city, etc.).

The radio station lists 300 of all cities are circular, as in FIG. 3. This means that using the dial up control 308 several times, the user can reach one by one all the radio stations in a city and repeat them, and the same applies backwards with the dial down control 312.

The Internet connects users with radio stations Internet broadcasting, as in the system 400 depicted in FIG. 4. Embodiments of the present invention may be deployed from a server 412 connected with a database 416. What users get at their PC client 408 from the server 412 is an HTML page that links them with the radio listening service.

Users navigate on the Internet 404 using a PC client 408 browser as in FIG. 4 to access an HTML page from server 412, which links the user with an audio stream from a radio station Internet broadcast.

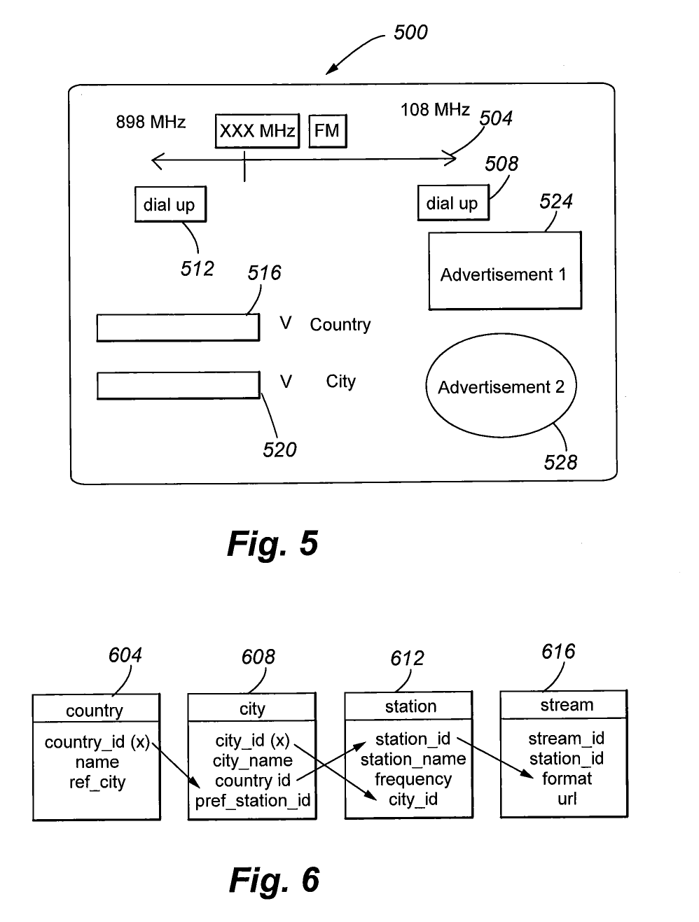

The HTML page or user interface 500 described in FIG. 5 has the following controls:
dial down 512
dial up 508
country and state selection 516
city selection 520
advertisement 1 (optional) 524
. . .
advertisement 2 (optional) 528
display configuration (optional) 504
calendar time radio selector (optional) (not shown)

One click at any control generates a Server Request from the client PC 408 to server 412. Each server request is answered by the server 412 modifying the HTML page thereby avoiding an HTML reload and performing the selected radio station. The dynamic change of the HTML page avoids blinking when reloading a page. Each request stores the following user parameters:
elapsed time
radio station
city
country
date and time stamp
advertisement selected

In this way, statistics on country, city, radio station, elapsed time, date and time, and advertisement selection are stored in the database 416 and used for determining user preferences, setting up user defaults, and providing listening feedback information to advertisement groups.

Registered users of the system can select their preferred country, city, and radio station to configure the display and also select a “no advertisement” option.

FIG. 6 depicts a country table 604 which is a list of all countries with country_id as a unique index code and preferred city of the country. City table 608 comprises a list of the name of all cities, city_id index code, country_id code where the city belongs and the preferred radio station of the city. Station table 612 provides a list of the name, frequency and the city_id code where the radio station is reached. The couple station_id, city_id is a unique index in the station table. Stream table 616 lists the address that is used to reach a radio station in each format. The couple station id, format is unique in this table. The mapping between country 604 and city 608 may be based upon the cities that reside within a particular country. The mapping between stations 612 and streams 616 may be based upon the web address where particular audio content from a radio station is streamed over the Internet. The mapping between city 608 and station 612 may be based upon the RF signals locally available at the city 608. Thus, in accordance with at least some embodiments of the present invention, a frequency selected at the user interface 600 may be mapped to a particular web address and therefore audio stream 616 based on the country 604 and/or city 608 selected since each country 604 and/or city 608 will have different locally available radio stations and therefore will be mapped to different web content providers.

The foregoing discussion of the invention has been presented for purposes of illustration and description. Further, the description is not intended to limit the invention to the form disclosed herein. Consequently, variations and modifications commensurate with the above teachings, within the skill or knowledge of the relevant art, are within the scope of the present invention. The embodiments described above are further intended to explain the best mode presently known of practicing the invention and to enable others skilled in the art to utilize the invention in other embodiments and with various modifications required by their particular application or use of the invention. It is intended that the appended claims be construed to include alternative embodiments to the extent permitted by the prior art.

What is claimed is:

1. A method of accessing an Internet radio station stream selected from a list, comprising:
providing controls for changing channel frequency above and below a selected radio station channel frequency, wherein the selected radio station channel frequency corresponds to a frequency of a radio station broadcast at a particular geographical location;
showing the selected radio station channel frequency;
providing the facility to change to channels above and below the selected radio station channel frequency via use of the controls; and
obtaining audio content associated with the selected radio station channel frequency from a web server.

2. The method of claim 1, further comprising:
obtaining usage statistics for the selected radio station channel frequency.

3. The method of claim 2, further comprising:
providing a city selector, wherein an address associated with the web server and used to obtain the audio content is mapped to the selected radio station channel frequency based on a value of the city selector.

4. The method of claim 3, further comprising:
providing a country selector, wherein the address is further mapped to the selected radio station channel frequency based on a value of the country selector.

5. The method of claim 1, further comprising:
providing the capability to program a channel change at a selected calendar time.

6. A computer readable medium comprising processor-executable instructions that, when executed, perform the steps of claim 1.

7. A computer readable medium comprising processor-executable instructions that, when executed, perform the steps of claim 2.

8. A system, comprising:
a web server; and
a client device comprising a user interface including controls for changing channel frequency above and below a selected radio station channel frequency, wherein the selected radio station channel frequency corresponds to a frequency of a radio station broadcast at a particular geographical location, wherein the user interface further includes a field adapted to depict the selected radio station channel frequency, wherein the user interface is further adapted to provide the facility to change to channels above and below the selected radio station channel frequency via use of the controls; and
a database, wherein the selected radio station channel frequency is mapped to an address associated with the web server and wherein audio content associated with the selected radio station channel frequency is provided from the web server to the client device.

9. The system of claim 8, wherein the address associated with the web server and used to obtain the audio content at the client device is mapped to the selected radio station channel frequency based on a value of a city selector.

10. The system of claim 8, wherein usage statistics for the address are monitored and combined with usage statistics associated with listeners actually listening to the selected radio station channel frequency via a radio frequency signal.
